(19) United States
(12) Patent Application Publication
(10) Pub. No.: US 2018/0330446 A1
(43) Pub. Date: Nov. 15, 2018

(54) NETWORK-BASED AUTOMATED INVESTING

(71) Applicant: LendingClub Corporation, San Francisco, CA (US)

(72) Inventors: Andreas Oesterer, Piedmont, CA (US); Abhijit Karpe, Fremont, CA (US)

(21) Appl. No.: 15/591,924

(22) Filed: May 10, 2017

(51) Int. Cl. G06Q 40/06; G06Q 40/02

(52) U.S. Cl. CPC G06Q 40/06; G06Q 40/025

(57) ABSTRACT

A method and system for automated investing using an omnibus account includes identifying a plurality of investors with a respective plurality of investor investment demands. An omnibus investment demand including the plurality of investor investment demands may be calculated. An omnibus investment order is generated based on the omnibus investment demand. An investment order may be executed on a loan inventory in the investment service according to the omnibus investment order to generate an omnibus fulfilled investment order of at least an omnibus investment portion of the loan inventory. The omnibus fulfilled investment order is distributed to the plurality of investors.

### TECHNICAL FIELD

The present application relates generally to electronic commerce and, in one specific example, to techniques for automating investing for ecommerce transactions.

### BACKGROUND

Network-based investing has become popular, resulting in competitive access to investment opportunities. One network-based investing category is peer-to-peer lending where a prospective borrower requests a loan by filling out a loan application using a network-based lending service. The network-based lending service receives specific information (e.g., name, social security number, purpose for the loan, etc.) relating to the prospective borrower. The network-based lending service then analyses the prospective borrower's information (e.g., obtains credit scores, credit history, etc.) and may approve the prospective borrower's loan application and associate a risk level to the approved loan application. The network-based lending service may accumulate several approved loan applications and periodically release the approved loan applications in batches.

An investor may use the network-based lending service to invest money by committing to provide the funds for various loans or various portions of the loans identified in the approved loan applications. When an investor commits to providing funds for loans, the network-based lending service may also be known as a network-based investing service. Because the network-based service described herein may perform both lending and investing services, the terms may be used interchangeably. Since the potential investors may prefer to invest in certain ones of the loans, there may be a competition among investors to commit to certain ones of the loans released in a batch. Accordingly, more sophisticated investors may have the technology or means to advantage themselves while disadvantaging other potential investors.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram illustrating an investor user interface, omnibus automated investing, and investment applications and that, in one example embodiment, are provided as part of application server(s) in the networked system.

FIG. 3 is a flowchart illustrating an example method for network-based investing using an omnibus investment account, in accordance with an example embodiment.

FIG. 4 is a flowchart illustrating an example method of distributing loans acquired with an omnibus investment account to individual investors, consistent with various embodiments.

FIG. 5 is a flowchart illustrating an example method for network-based investing including purchasing and distributing acquired loans, in accordance with an example embodiment.

FIG. 6 is a chart illustrating results from investing using an omnibus investment account, according to an example embodiment.

FIG. 7 is a block diagram of a machine in the example form of a computer system within which instructions may be executed for causing the machine to perform any one or more of the methodologies discussed herein.

### DETAILED DESCRIPTION

Example methods and systems are described for improving the access to or competition for investment for network-based loans by investors that may not have specific investment selection strategies or investors that may choose to rely on an automated-investing (AI) investment strategy. Such investors may be described herein as “automated-investing investors” or “AI investors.” While AI investors may include non-institutional investors (i.e., investors without a self-managed investment strategy), access to automated-investing services may be utilized by any entity including individuals and institutions. It will be evident, however, to one skilled in the art that the present inventive subject matter may be practiced without these specific details. As used herein, “self-managed investors” may describe investors, whether individuals or institutions, that engage in network-based investing in using their own (i.e., self-managed) investment methodologies when engaging with the network-based lending service. Conversely as used herein, “automated-investing investors” may describe investors that have no proprietary or collective investment methodologies when engaging with the network-based lending service and rely upon services provided by an automated investing service using an automated-investing investment strategy.

In general, network-based investing may be very competitive. The network-based investing service includes borrowers who seek loans for various reasons, and investors who may be interested in investing in (funding) various loans or fractions of loans of borrowers. However, loans are not fungible as different borrowers present differing risks and different purposes for the loans may also present yet different additional risks. Accordingly, investors may be selective and may have interest only in loans with risks and rewards that align with the investor's investment preferences.

Since some loans may be more desirable to investors, there is an urgency to identify and select the more desirable loans before other investors select the desirable loans thereby making them unavailable. Accordingly, time is of the essence when a periodic listing period for the available loans begins. Therefore, investors such as third-party self-managed investors, with means to develop their own automated investing engine, may have an advantage during the beginning of the listing period when new loans become available for investment. Accordingly, automated-investing investors may be disadvantaged and never get an opportunity to invest in loans that meet their investment preferences.

Further, even if the network-based investing service individually serviced a plurality of investment orders from a plurality of automated-investing investors, each of the investors' investment orders would be handled sequentially which could take more time than the execution of the self-managed investor's investment order. Accordingly, only a first few investment orders of the automated-investing investors may be able to be executed before the desirable loans may be fully funded (no longer available) by quicker investment engines (e.g., servers) of the self-managed investors.

The various embodiments described herein allow the network-based investing service to provide a mechanism for automated investing, for example to automated-investing investors, that can compete with the investment engines of self-strategized investors for available loans at the beginning of each periodic listing period of the available-loan inventory including the available loans. In the various embodiments, the automated-investing investors may have their individual investor demands grouped into a single omnibus investment demand which may include an accumulation of the various individual investor investment demands of the individual investors. A single investment request based on the omnibus investment demand may then be generated and executed, in an order processed by the investment server, at the beginning of the next periodic listing period of the available-loan inventory. Loans and fractions of loans may be acquired (e.g., funded or purchased) by the omnibus investment account during the listing period of the available loan inventory. Thereafter, the holdings of the omnibus investment account may be reapportioned back to the individual accounts of the automated-investing investors and reapportioned as individual investor holdings.

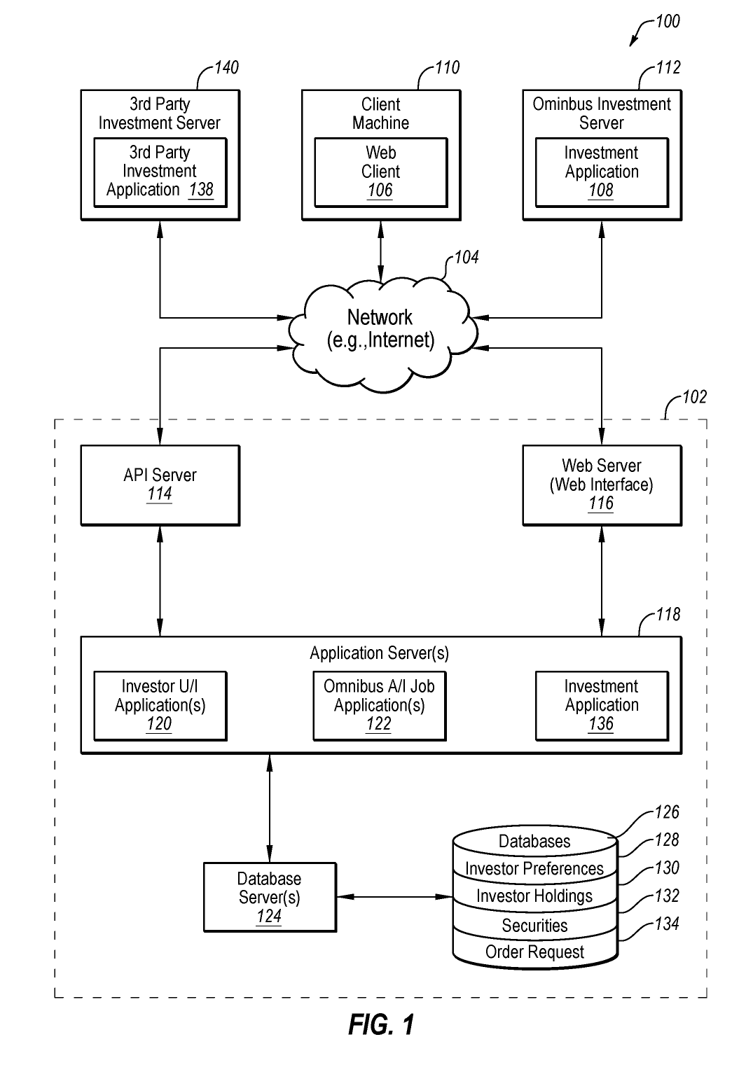

FIG. 1 is a network diagram depicting a client-server system 100, within which one example embodiment may be deployed. A networked system 102, in the example forms of a network-based investing system, provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and an investment application 108 executing on respective devices 110 and 112.

An Application Program Interface (API) server 114 and a web server 116 are coupled to, and provide programmatic and web interfaces respectively to, one or more application servers 118. The application servers 118 host one or more investor user interface applications 120 and omnibus automated investing job applications 122. The application servers 118 are, in turn, shown to be coupled to one or more database servers 124 that facilitate access to one or more databases 126.

Databases 126 includes an investor preference database 128 configured to store investor information and preferences such as the investor account information, investment account balance, investment preference instructions or guidelines including amounts of investment funds and respective filters for criteria of acceptable prospective loans to which the investor would agree to fund. Databases 126 also includes an investor holdings database 130 configured to identify the current investor holdings (i.e., previously funded loans). Databases 126 further includes a securities database 132 configured to identify available loan inventory. Databases 126 yet further includes an order request database 134 configured to retain generated investment order requests for execution by the investment application 36 during a listing period of the available loan inventory.

The investor user interface application 120 may provide a number of user interface functions and services to users who access the networked system 102. The omnibus automated investment (AI) job application 122 may likewise provide a number of investment services and functions on behalf of automated-investing investors of the investing service. While the investor user interface and omnibus automated investment job applications 120 and 122 are shown in FIG. 1 to both form part of the networked system 102, it will be appreciated that, in alternative embodiments, the omnibus automated investment application 122 may form part of an automated investing job service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various user interface and omnibus automated investing job applications 120 and 122 could also be implemented as standalone software programs, which do not necessarily have networking capabilities.

The web client 106 accesses the investor user interface application 120 via the web interface supported by the web server 116. Similarly, the omnibus investment server 112 accesses the various services and functions provided by the investment application 136 via the programmatic interface provided by the API server 114. The investment application 108 may, for example, be an investor application to enable automated-investing investors to compete for network-based loans on the networked system 102.

FIG. 1 also illustrates a third party investment application 138, executing on a third party investment server 140, as having programmatic access to the networked system 102 via the programmatic interface provided by the API server 114. For example, the third party investment application 138 may also engage in competitive investing in network-based loans.

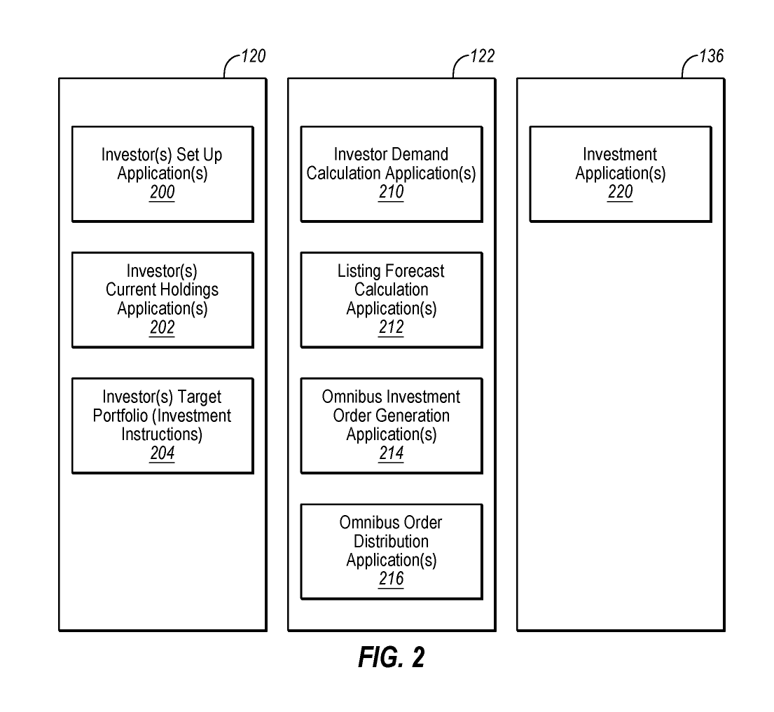

FIG. 2 is a block diagram illustrating an investor user interface, omnibus automated investing job, and investment applications 120, 122, and 136 that, in one example embodiment, are provided as part of application server(s) 118 in the networked system 102. The applications 120, 122 and 136 may be hosted on dedicated or shared server machines (not shown) that are communicatively coupled to enable communications between servers. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of investing mechanisms whereby investors, both self-managed investors and automated-investing investors, may competitively engage in selection of network-based available loan inventory. To this end, the investor user interface application 120 is shown to include an investor(s) set up application 200, which supports a user identification in the networked system 102. The investor(s) set up application 200 may include login, user identification, financial institution information, available investment capital, and any other identification, security, and preference information allowing an investor to access the networked system 102. The above set up information may be stored in the investor(s) preferences database 128 of FIG. 1, as accessed via the database server(s) 124 also of FIG. 1.

The investor user interface application 120 is also shown to include an investor current holdings application 202, which identifies the current holdings of the investor(s). The investor current holdings may be holdings of network-based loans previously funded through manual investing on the networked system by the investor, or holdings funded through a previous iteration of the omnibus automated investing mechanisms as described herein. The investor's current holding may be stored in the investor holdings database 130 of FIG. 1, as accessed via the database server(s) 124 of FIG. 1.

The investor user interface application 120 is shown to further include an investor(s) target portfolio application 204, which may include the investor's investment instructions or preferences. The investment instructions may include target apportionments of network-based loans from various categories including grade (i.e., risk) categories, term of the loan categories, geographic categories, industry categories, purpose categories, credit score categories, loan-to-value categories, or any other categories or parameters.

The networked system 102 further includes the omnibus automated investing job application server 122, which creates an omnibus investment order based on the omnibus investment demand of the plurality of automated-investing investors using a single omnibus account. The omnibus investment order may then be executed by the investment application 108 on the omnibus investment server 112 which may invest via the networked system 102. The omnibus automated investing job application server 122 is shown to include an investor demand calculation application 210, which may calculate the investor's demands for a next listing period of the available loan inventory. The investor demand calculation application 210 may access the investor holdings database 130 of FIG. 1 to determine current investment holdings of the investors. Further, the investor demand calculation application 210 may access the investor preferences database 128 to determine the investor's investment instructions or preferences and the investor's available investment capital for investing in a next listing period of the available loan inventory. The investor demand calculation application 210 generates an investor demand for further holdings for each of the plurality of investors based on the current investment holdings of the investors and the target investment holdings of the investors.

The omnibus automated investing job application server 122 is shown to also include a listing forecast calculation application 212, which creates a forecast of a prospective loan inventory for the next listing period based on one or more previous or historical loan inventories of actual loan inventory during actual previous listing periods. The historical data may include various data from previously available loans and results of previous listing periods. The historical data may include grade (i.e., risk) categories, term of the loan categories, geographic categories, industry categories, purpose categories, credit score categories, loan-to-value categories, or any other categories or parameters of loans in past loan inventory in past listing periods. The historical data may include results from the one or more past loan investment events. The listing forecast calculation application 212 may obtain the historical data from the investor holding database 130 and the securities database 132 of FIG. 1 via one or more database servers 124 of FIG. 1.

The securities database 132 may include both funded securities (e.g., acquired or purchased loans) and unfunded securities (e.g., yet-to-be acquired or prospective loans). In one embodiment, in order to maintain fairness between the third-party investment server 140 and the omnibus automated-investing investors, the listing forecast application 212 does not have access to the actual loan inventory that will be available in the next listing period.

The omnibus automated investing job application 122 may further include an omnibus investment order generation application 214, which generates an omnibus investment order request based on the omnibus investment demand for further holdings generated in the investor demand calculation application 210 and the forecasted investment loan supply for the next listing period generated in the listing forecast calculation application 212. The omnibus investment order is sent to the omnibus investment server 112 located outside of the networked system 102 which may then generate an investment order request of the loan inventory when the next listing period begins. Locating the omnibus investment server 112 with the omnibus investment order outside of the networked system 102 ensures fairness with other third-party investment servers 140 when competing for available loans during each of the listing periods.

The networked system 102 as shown includes an investment application 220 which receives and processes investment order requests, during each of the listing periods, as received from the third-party investment server 140, the omnibus investment server 112, and other investors via a client machine 110 and web server 116. The third-party investment server 140 and the omnibus investment server 112, for example during the next listing period of loan inventory, acquire or fund loans (e.g., securities) from the available loan inventory according to the specifics of the investment order requests.

After acquisition or funding of ones of the available loans matching the criteria of the omnibus investment order request, the acquired loans (e.g., securities) need to be allocated from an omnibus investment account to individual investors' holdings. The omnibus automated investing job application 122 is shown to include an omnibus order distribution application 216, which distributes individual loans and fractions of the acquired loans (e.g., securities) obtained by the omnibus investment account in the concluded next loan investment event to individual investors.

The acquired loans and fractions of loans acquired by the omnibus investment account may be distributed according to the proportions used in the generation of the investment order request or according to various other preferences. Specifically, the distribution of the omnibus fulfilled investment order of the portion of the loan inventory from the current listing period may include calculating a distribution priority score for each of the plurality of the investors. Also, the plurality of investors are ordered based on the distribution priority score of each of the plurality of investors. Further, the omnibus investment portion of the loan inventory is distributed to the plurality of investors according to the ordered plurality of investors. In other embodiments, the distribution of the omnibus investment portion of the loan inventory may include distributing a first portion of the omnibus investment portion of the loan inventory to the plurality of investors according to the ordered plurality of investors and distributing a second portion of the omnibus investment portion of the loan inventory to ones of the plurality of investors where the investor investment demand remains unsatisfied by distribution of the first portion.

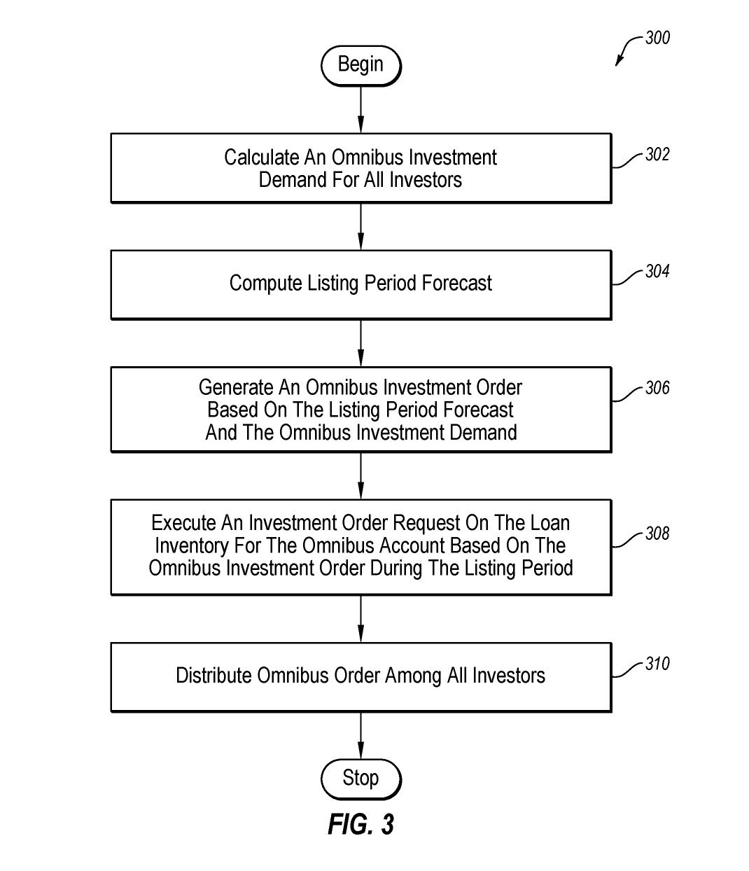

FIG. 3 is a flowchart illustrating an example method 300, consistent with various embodiments. As discussed previously, network-based investing can be very competitive. Investors may be selective and may have interest only in loans with risks and rewards that align with the investor's investment preferences as identified in the investor preferences database 128, discussed above with respect to FIG. 1.

At step 302, investor investment demands are calculated for each of the investors participating in the automated investing service. The investor investment demands may be calculated by investor demand calculation application 210 of FIG. 2, which may calculate the investor demand for a next loan investing event. The investor demand calculation application 210 may access the investor holdings database 130 of FIG. 1 to determine current investment holdings of the investors. Further, the investor demand calculation application 210 may access the investor preferences database 128 to determine the target investment holdings of the investor and the investor's available capital for investing. The investor demand calculation application 210 generates an investor demand for further holdings based on the current investment holdings of the investors and the target investment holdings of the investors.

At step 304, a forecast of a prospective loan inventory for the next loan listing period is calculated by listing forecast calculation application 212 of FIG. 2. In one embodiment, the forecast may be generated based on one or more historical loan inventories and the omnibus investment order may be generated based on both the omnibus investment demand and the forecast of the loan inventory.

At step 306, an omnibus investment order may be generated that is based on the forecast and the omnibus investment demand. The omnibus investment order may be generated by the omnibus investment order generation application 214 of FIG. 2 which generates an omnibus investment order based on the omnibus investment demand for further holdings generated in the investor demand calculation application 210 and the forecast of a prospective loan inventory for the next listing period generated in the listing forecast calculation application 212. The omnibus investment order may be sent to the omnibus investment server 112 located outside of the networked system 102. Locating the omnibus investment server 112 with the omnibus investment order outside of the networked system 102 ensures fairness with other third-party investment servers 140 when competing for available loans during each of the listing periods.

In step 308, an investment order request is generated for execution on the loan inventory during the listing period. The investment order request is based on the omnibus investment order. The investment request may be generated by the omnibus investment server 112 alongside any other investment order requests from any investment servers such as the third-party investment server 140. The investment order requests from servers 112 and 140 may be sent to the API server 114 for execution by the investment application 220 of FIG. 2 executing on the investment server 136. The investment server 136 receives and processes investment order requests from both the third-party investment server 140 and the omnibus investment server 112 during each of the listing periods. The third-party investment server 140 and the omnibus investment server 112, for example during the next loan listing period, acquire or funds loans (e.g., securities) from the available loans according to the specifics of the investment order requests. The execution of the investment order request may include applying filters identified in the omnibus investment order that identifies loans in the loan inventory that conform to the omnibus investment demands.

In step 310, the various loans and fractions of loans in the omnibus fulfilled investment order are distributed or reapportioned back to the individual investors as individual investor holdings for each of the individual automated-investing investors. The omnibus fulfilled investment order may be distributed by the omnibus order distribution application 216 of FIG. 2, which distributes individual loans and fractions of the acquired loans (e.g., securities) obtained by the omnibus investment account to the individual automated-investing investors. The acquired loans and fractions of loans in the omnibus fulfilled investment order acquired by the omnibus investment account may be distributed according to the proportions used in the generation of the omnibus investment order or according to various other preferences.

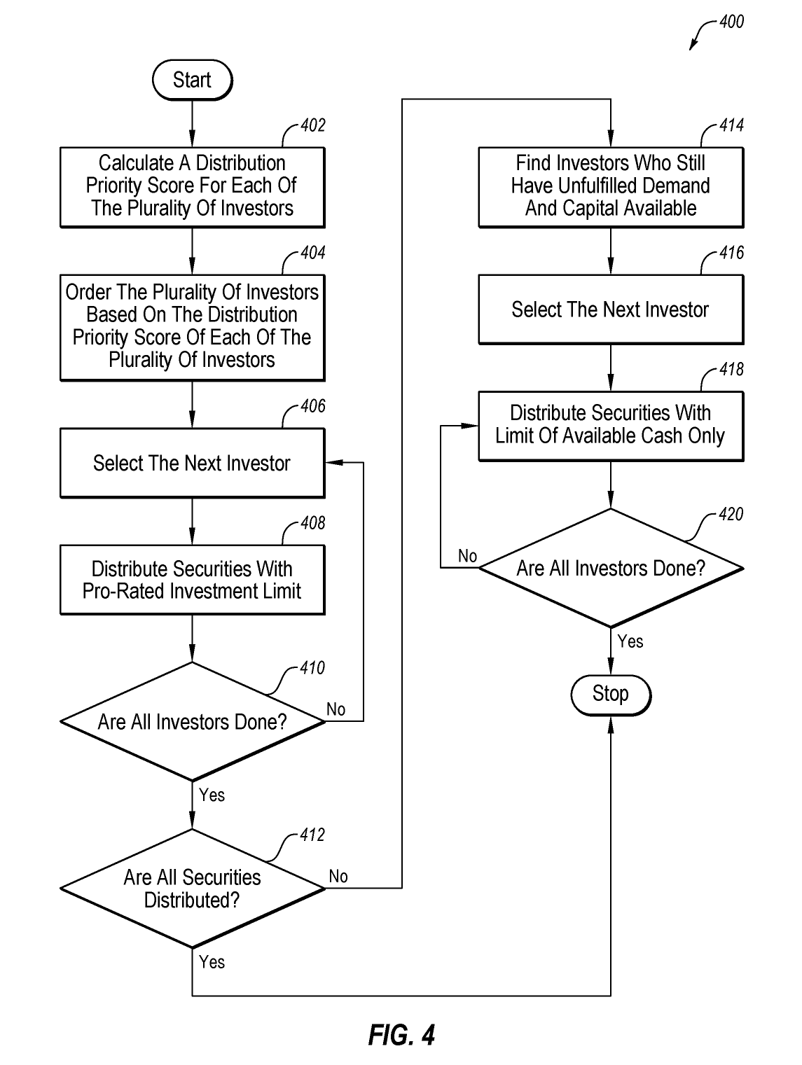

FIG. 4 is a flowchart illustrating an example method 400, consistent with various embodiments. The method 400 illustrates a distribution of an omnibus fulfilled investment order acquired or funded by the omnibus automated investing process.

In a step 402, a process calculates a distribution priority (“hunger”) score for each of the plurality of investors of the omnibus automated investing process for prioritized distribution of the acquired loans. Those investors with a higher score or ranking are first allocated a portion of the acquired loans.

In a step 404, a process orders the plurality of investors based on the distribution priority score of each of the plurality of investors. The investors are assigned to a ranked order according to the process described in step 402. Ordering or ranking may be based on various factors including prioritizing investors that have a larger amount of investment capital. Further, investors may be prioritized when the loan inventory for a previous listing period was incompatible with the investor's preferences or acquired loans in a previous listing period were distributed without any allocation to the investor.

In a step 406, the remaining highest ranked or ordered investor is selected for distribution of a portion of the omnibus investment portion of the loan inventory acquired during the listing period.

In a step 408, the portion of the omnibus investment portion of the loan inventory acquired during the listing period are distributed to the investors according to the investor's order based on the distribution priority score. The acquired loans are distributed, and distribution may include pro-rated distribution according to investment limits based on investor preferences or instructions and the available loan inventory during the listing period. The allocation of acquired loans then becomes current holdings for the respective investors, and are recorded in the investor holdings database 130.

In a step 410, a query determines if all ranked or ordered investors have received an apportionment of the omnibus investment portion of the loan inventory acquired during the listing period. If there are ranked or ordered investors that have not had an opportunity for an apportionment of the omnibus investment portion of the loan inventory acquired during the listing period, then processing returns to the step 406 where the next ranked or ordered investor is selected for apportionment.

In a step 412, a determination identifies any remaining securities that have not been distributed to investors.

In a step 414, investors with remaining investment capital and unfulfilled demand may be identified.

In a step 416, investors with unfulfilled demand may be sequentially selected.

In a step 418, remaining unapportioned acquired loans from the omnibus investment portion of the loan inventory may be distributed to the selected investor based on various factors including the selected investor's remaining investment capital.

In a step 420 a query determines if all investors with remaining investment capital and unfulfilled demand have received a further apportionment. If not, processing returns to the step 418 where further apportionment may occur to the next investor with remaining investment capital and unfulfilled demand.

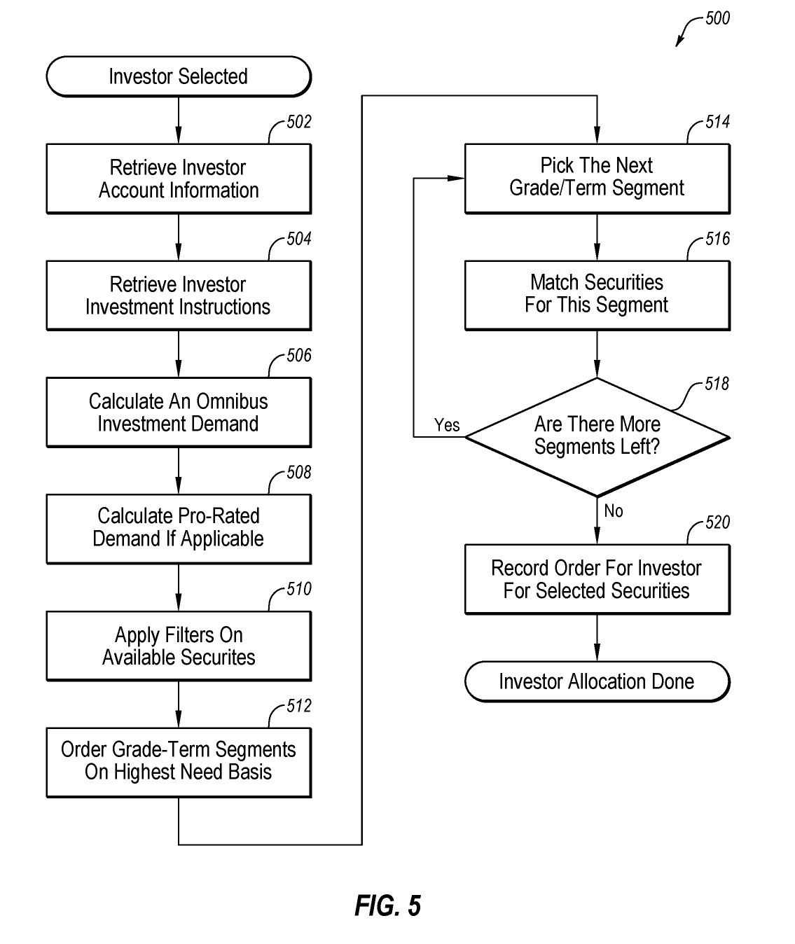

FIG. 5 is a flowchart illustrating an example method 500, consistent with various embodiments. The method 500 illustrates an automated investing process for an investor that participates in the omnibus automated investing service.

In step 502, the investor demand calculation application 210 fetches account information relating to an investor from the investor preferences database 128. The investor account information may also include the investor's available capital for further investing and investor current holdings from the investor holdings database 130.

In step 504, the investor demand calculation application 210 retrieves investment instructions from the investor's user preference database 128 which may include filters identifying specific investing preferences such as grades of acceptable loans (or fractions of loans), terms of acceptable loans (or fractions of loans), as well as other acceptable loan characteristics.

In step 506, the investor demand calculation application 210 calculates an investment demand for the investor based on the investor's current holdings as identified in the investor holdings database 130 and the investor's target investment portfolio as identified in the investor preferences database 128. An omnibus investment demand is generated based on an accumulation of the plurality of individual investor demands.

In step 508, the individual investor demands or the omnibus investment demand may need to be pro-rated to restrict the demand to a level that allows more or all participants in the investing service to at least partially participate in automated investing. In one embodiment, an omnibus investment order may be generated by pro-rating or restricting investors in a first pass through each of the investors of the automated investing service using pro-rated investment order requests from the omnibus investment server 112 to the investment application 136 on server 118. In another embodiment, the pro-rating restriction may be suspended for subsequent passes through each of the automated-investing investors in attempting to fill the investment order.

In step 510, execution of the omnibus investment order may occur by issuing investment order requests which may include applying filters in the investment application corresponding to the omnibus investment order. The filters identify loans in the loan inventory that conform to the omnibus investment demands.

In step 512, the omnibus investment demands may be ordered according to overall demand for loans with specific characteristics, such as grade and term. These, for example, grade-term characteristics may be called “segments.” The segments may be ordered according to overall demand allowing the loan with the highest demand to be executed first, thereby improving the probability of fulfilling the most investor demand.

In step 514, the investor demand segments with the remaining greatest demand is identified for use in picking or acquiring loans from the loan inventory that conform to the segment.

In step 516, the loans from the loan inventory matching or conforming to the current investor demand segment, are acquired or funded.

In step 518, the omnibus investment order is analysed to determine if lesser demand investor demand segments remain that have not been matched or used to acquire loans from the loan inventory. If so, processing returns to step 514.

In step 520, the acquired or funded loans are recorded as being acquired by the omnibus investment account.

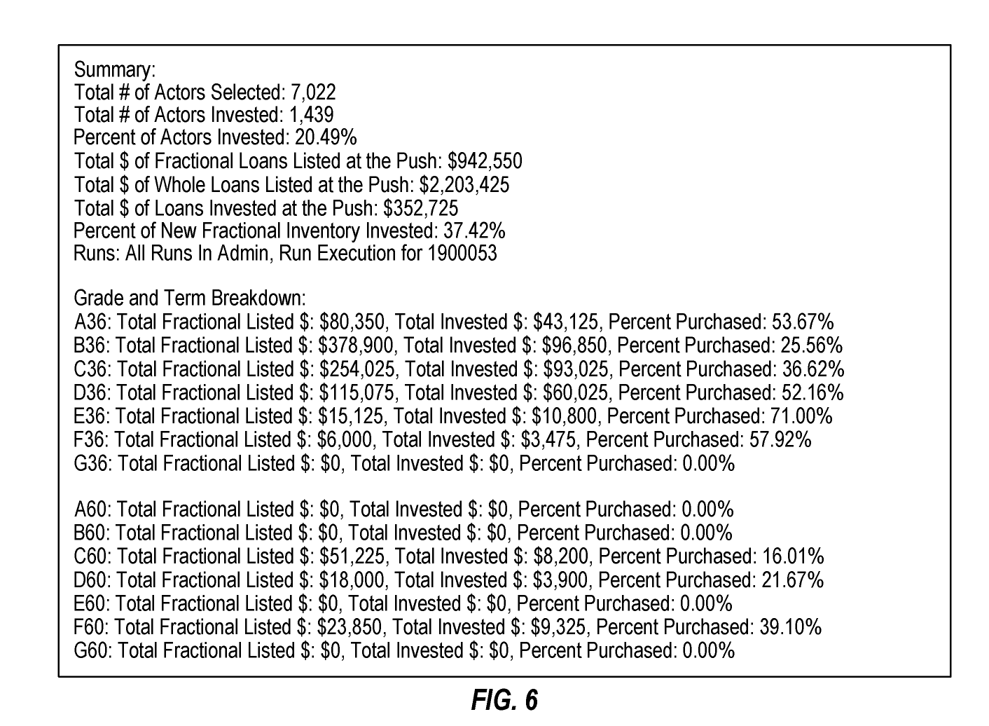

FIG. 6 illustrates an example listing of a summary of the results from the omnibus automated investing process according to various embodiments. The Summary illustrates, for example, a total of 7,022 investors participated in the omnibus automated investing process described herein where, for example, 1439 investors, or 20.49%, received a distribution of loans during the listing period. Therefore, the remaining investors were unsuccessful based on individual investment instruction or preferences that did not match any remaining loans in the loan inventory at the time their requests were executed.

Also under the Summary heading, for example, are capital totals for the loans listed in the loan inventory during the listing period. It is noted that the omnibus investment service may be self restricted to seek less than all of the loan inventory in order to allow other investors, such as third-party self-managed investors or individual investors not participating in the omnibus automated investing process, to have access to remaining portions of the loan inventory.

Also listed, for example, in FIG. 6 are Grade (e.g., risk) and Term of loan characteristics or “segments” for the loan inventory of the listing period. For each grade, for example, the Listed value, Total Invested value, and Purchased (i.e., funded or acquired) percentages are listed.

Certain embodiments are described herein as including logic or a number of components, modules, or mechanisms. Modules may constitute either software modules (e.g., code embodied (1) on machine-readable storage or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 702 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 702, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 702 or processor-implemented modules. The performance of certain of the operations may be distributed among the one or more processors 702, not only residing within a single machine, but deployed across a number of machines. In some example embodiments, the processor 702 or processors 702 may be located in a single location (e.g., within a home environment, an office environment or as a server farm), while in other embodiments the processors 702 may be distributed across a number of locations.

The one or more processors 702 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 702, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 702 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 702), or a combination of permanently and temporarily configured hardware may be a design choice. Below are set out hardware (e.g., machine) and software architectures that may be deployed, in various example embodiments.

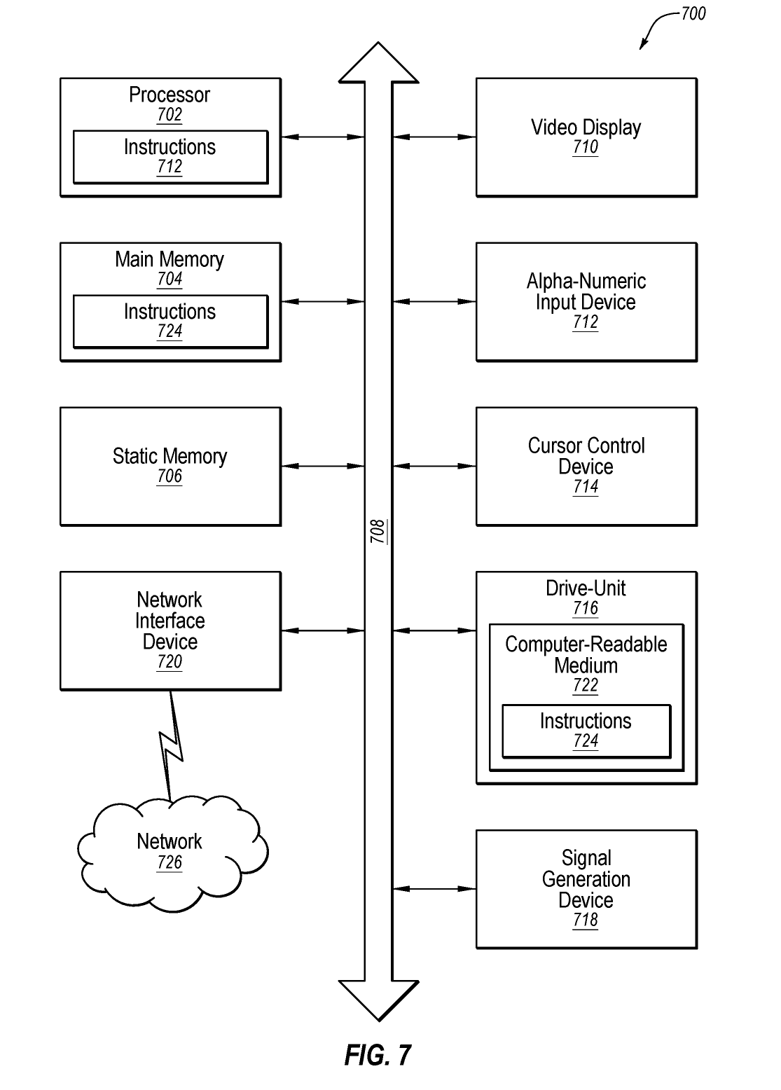

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (e.g., cursor control) device 714 (e.g., a mouse), a disk drive unit 716, a signal generation device 718 (e.g., a speaker) and a network interface device 720.

The disk drive unit 716 includes a computer-readable medium 722, which may be hardware storage, on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting computer-readable media 722.

While the computer-readable medium 722 is shown in an example embodiment to be a single medium, the term “computer-readable medium” may include a single medium or multiple media (e.g., a centralized or distributed database, and/or associated caches and servers) that store the one or more instructions 724 or data structures. The term “computer-readable medium” shall also be taken to include any tangible medium that is capable of storing, encoding or carrying instructions 724 for execution by the machine and that cause the machine to perform any one or more of the methodologies of the present disclosure or that is capable of storing, encoding or carrying data structures utilized by or associated with such instructions 724. The term “computer-readable medium” shall accordingly be taken to include, but not be limited to, solid-state memories, and optical and magnetic media. Specific examples of computer-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 724 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method, comprising:
identifying a plurality of investors with a respective plurality of investor investment demands;
calculating an omnibus investment demand comprised of the plurality of investor investment demands;
generating an omnibus investment order based on the omnibus investment demand;
executing an investment order request of a loan inventory in an investment service according to the omnibus investment order to generate an omnibus fulfilled investment order of at least an omnibus investment portion of the loan inventory; and
distributing the omnibus fulfilled investment order of the omnibus investment portion of the loan inventory to the plurality of investors.

2. The method of claim 1, wherein generating the omnibus investment order comprises:
generating a forecast of a prospective loan inventory based on one or more previous loan inventories of a respective one or more previous listing periods; and
generating an omnibus investment order based on both the omnibus investment demand and the forecast of the loan inventory.

3. The method of claim 2, further comprising:
reducing the omnibus investment demand when the forecast of the loan inventory exceeds one or more previous loan inventories.

4. The method of claim 2, wherein generating an omnibus investment order based on both the omnibus investment demand and the forecast of the loan inventory includes:
identifying third-party historical investment demands of third-party investors on the investment service; and
generating an omnibus investment order based on both the omnibus investment demand, the forecast of the loan inventory and the third-party historical investment demands.

5. The method of claim 1, wherein each of the investor investment demands further includes respective investment instructions identifying loans or fractions of loans the investor will accept purchase of from the loan inventory.

6. The method of claim 5, wherein the generating an omnibus investment order further comprises the investment instructions identifying characteristics of the loans or the fractions of loans the investor will accept purchase of from the loan inventory.

7. The method of claim 6, wherein the characteristics include at least one of determined risk associated with the loan and a term of the loan.

8. The method of claim 6, wherein the omnibus investment order includes ordered instructions ordered from greatest to least total value of the loans or the fractions of loans from all of the investor investment demands with same characteristics.

9. The method of claim 8, wherein the investment order request on the loan inventory, comprises:
purchasing the loans or the fractions of loans in the loan inventory with the omnibus investment demand according to the ordered instructions of the omnibus investment order until all of the ordered instructions have been executed or the loan inventory has been exhausted.

10. The method of claim 1, wherein distributing the omnibus fulfilled investment order of the omnibus investment portion of the loan inventory to the plurality of investors includes:
calculating a distribution priority score for each of the plurality of investors;
ordering the plurality of investors based on the distribution priority score of each of the plurality of investors; and
distributing the omnibus investment portion of the loan inventory to the plurality of investors according to the ordered plurality of investors.

11. The method of claim 10, wherein the distributing the omnibus investment portion of the loan inventory to the plurality of investors according to the ordered plurality of investors includes:
distributing a first portion of the omnibus investment portion of the loan inventory to the plurality of investors according to the ordered plurality of investors; and
distributing a second portion of the omnibus investment portion of the loan inventory to ones of the plurality of investors where the investor investment demand remains unsatisfied by distribution of the first portion.

12. The method of claim 1, wherein the loan inventory of the investment service is periodically released.

13. A non-transitory machine-readable storage medium embodying instructions that, when executed by a machine, cause the machine to perform operations comprising:
identifying a plurality of investors with a respective plurality of investor investment demands;
generating an omnibus investment demand comprised of the plurality of investor investment demands;
generating an omnibus investment order based on the omnibus investment demand;
executing an investment order request of a loan inventory in an investment service according to the omnibus investment order to generate an omnibus fulfilled investment order of at least an omnibus investment portion of the loan inventory; and
distributing the omnibus fulfilled investment order of the omnibus investment portion of the loan inventory to the plurality of investors.

14. The non-transitory machine-readable storage medium of claim 13, wherein the operations for generating the omnibus investment order comprise:
generating a forecast of a prospective loan inventory based on one or more historical loan inventories; and
generating an omnibus investment order based on both the omnibus investment demand and the forecast of the loan inventory.

15. The non-transitory machine-readable storage medium of claim 13, wherein each of the investor investment demands further includes respective investment instructions identifying loans or fractions of loans the investor will accept purchase of from the loan inventory.

16. The non-transitory machine-readable storage medium of claim 13, wherein the operations for distributing the omnibus fulfilled investment order of the omnibus investment portion of the loan inventory to the plurality of investors includes:
calculating a distribution priority score for each of the plurality of investors;
ordering the plurality of investors based on the distribution priority score of each of the plurality of investors; and
distributing the omnibus investment portion of the loan inventory to the plurality of investors according to the ordered plurality of investors.

17. A system, comprising:
an omnibus automated investing server configured to:
identify a plurality of investors with a respective plurality of investor investment demands;
generate an omnibus investment demand comprised of the plurality of investor investment demands;
generate an omnibus investment order based on the omnibus investment demand;
an investment server configured to execute an investment order request of a loan inventory in an investment service according to the omnibus investment order to generate an omnibus fulfilled investment order of at least an omnibus investment portion of the loan inventory; and
the omnibus automated investing server further configured to distribute the omnibus fulfilled investment order of the omnibus investment portion of the loan inventory to the plurality of investors.

18. The system of claim 17, wherein the omnibus automated investing server configured to generate the omnibus investment order is configured to:
generate a forecast of a prospective loan inventory based on one or more historical loan inventories; and
generate an omnibus investment order based on both the omnibus investment demand and the forecast of the loan inventory.

19. The system of claim 17, wherein each of the investor investment demands further includes respective investment instructions identifying loans or fractions of loans the investor will accept purchase of from the loan inventory.

20. The system of claim 17, wherein the omnibus automated investing server configured to distribute the omnibus fulfilled investment order of the omnibus investment portion of the loan inventory to the plurality of investors is configured to:
calculate a distribution priority score for each of the plurality of investors;
order the plurality of investors based on the distribution priority score of each of the plurality of investors; and
distribute the omnibus investment portion of the loan inventory to the plurality of investors according to the ordered plurality of investors.
